(19) United States
(12) Patent Application Publication
(10) Pub. No.: US 2008/0104868 A1
(43) Pub. Date: May 8, 2008

(54) Graphic organizers

(76) Inventor: Jeanine Van Drie, Lincoln, CA (US)

Correspondence Address: LITMAN LAW OFFICES, LTD., P.O. BOX 15035, CRYSTAL CITY STATION, ARLINGTON, VA, 22215, US

(21) Appl. No.: 12/000,325

(22) Filed: Dec. 11, 2007

Related U.S. Application Data
(62) Division of application No. 11/174,624, filed on Jul. 6, 2005, now abandoned.
(60) Provisional application No. 60/592,220, filed on Jul. 30, 2004.

(51) Int. Cl. G09D 3/00

(52) U.S. Cl. 40/110

(57) ABSTRACT

The graphic organizer is a flexible sheet of material having a property whereby the sheet will cling on contact to a white board surface or the like. Various visual indicia are printed on the material surface, such as a monthly calendar, a weekly calendar, a lined sheet having regularly spaced lines or, alternatively, a lined sheet having doubled lines alternating with dashed lines, and a coordinate graph layout with numbered positive and negative X and Y axes. The sheet material may be transparent or opaque. In use, a graphic organizer is applied to a surface, such as a white board surface. A dry erase marker is used to mark on the graphic organizer. Additional, smaller pieces of the sheet material may be provided with particular indicia printed thereon, such as days of a week, or numbers, the small overlay pieces being rearrangable on the graphic organizer surface.

### CROSS-REFERENCE TO RELATED APPLICATION

This application claims the benefit of U.S. Provisional Patent Application Ser. No. 60/592,220, filed Jul. 30, 2004.

### BACKGROUND OF THE INVENTION

1. Field of the Invention

The present invention relates generally to organizing devices. More specifically, the invention is a static clinging vinyl sheet having special indicia adapted for placement over a white board, the vinyl sheet clinging to the white board due to the inherent electrostatic nature of the material. A colored erasable marker pen, for example, is used to place indicia on the vinyl sheet.

2. Description of the Related Art

The related art of interest describes various training aid devices, but none discloses the present invention. There is a need for a device that permits adding temporary indicia on a transparent plastic overlay sheet as a teaching or scheduling aid. The related art of interest will be distinguished in the order of perceived relevance to the present invention.

U.S. Pat. No. 6,324,777 B1 issued on Dec. 4, 2001, to Chi L. Ngan describes a static cling calendar having an electrostatic swingable cover which will attract a sheet underlying the cover so that when the cover is swung, the underlying sheet will be picked by the cover to expose the underside of the sheet as well as the next succeeding sheet. The calendar is distinguishable for requiring multiple electrostatic sheets.

U.S. Pat. No. 3,797,134 issued on Mar. 19, 1974, to Eldon S. Wingerd describes an arithmetic concepts display board having a grid portion defined by ridges for equal squares with pegs rising from every other gridline intersection on every other grid line. The board is distinguishable for requiring pegs.

U.S. Pat. No. 3,638,332 issued on Feb. 1, 1972, to Ann M. Jones describes a writing readiness paper for teaching children to print on the proper lines consisting of a paper sheet having a plurality of a series of different colored horizontal parallel lines thereon. The writing paper is distinguishable for requiring a series of different colored horizontal and parallel lines.

U.S. Design Pat. No. 39,492 issued on Sep. 1, 1908, to William J. Guy describes a shorthand note sheet having a parallel series of bold wavy lines separated by a dotted line and a line. The shorthand note sheet is distinguishable for requiring a specific series of three line types in parallel.

U.S. Pat. No. 3,191,318 issued on Jun. 29, 1965, to Robert G. Hoffmann describes a mathematic teaching aid comprising a rectangular board of wood, metal or plastic partially perforated with a plurality of holes provided in a pattern of a rectangular grid representing a two-dimensional space. A horizontal groove for the X-axis and a vertical groove for the Y-axis are formed on the board. The board is distinguishable for requiring a board having the XY graph, but not the graph on a flexible sheet above the board.

U.S. Pat. No. 3,461,573 issued on Aug. 19, 1969, to Willard O. Stibal describes a modern mathematics demonstration unit board comprising a coordinate graph with equal unit areas and X and Y axes dividing the board into quadrants. One quadrant has trigonometric indicia along the top and side, and angle indicia corresponding to the trigonometry. Another quadrant has numerical base indicia adjacent an upper edge. Volumetric unit members increasing in size from one to several units, and mathematical symbol elements are attachable to the board. The volumetric unit is equal to the cube of a unit area of the coordinate graph. The unit board is distinguishable for requiring mathematical units.

U.S. Pat. No. 3,514,874 issued on Jun. 2, 1970, to Raymond A. Strohl describes a longhand-writing guide comprising a rectangular board or platen having a one-piece frame and an insertion slot on one side. The platen has horizontal and vertical guide lines and other indicia which show through the sheet to help the writer keep straight lines and vertical alignment of the paragraph and other indentations. The inner edge of the frame has notches for locating page numbers. The longhand-writing guide board is distinguishable for requiring a frame with guide lines.

U.S. Pat. No. 4,028,826 issued on Jun. 14, 1977, to Angelo Brandifino et al. describes a perpetual memory bank calendar comprising a framed window behind which different month cards including a memorandum space being erasable, different colored stickers being mounted adjacent each memorandum entry with matching stickers over the specific date on the calendar. An endless movable belt is positioned over the month card and imprinted with the days of the week. The device is distinguishable for requiring a calendar.

U.S. Pat. No. 4,114,298 issued on Sep. 19, 1978, to Robert L. Sandelman describes a perpetual calendar comprising a rectangular board has transparent letters and numbers positioned in a predetermined matrix arrangement on a transparent sheet. Within the matrix arrangement are abbreviation for each day, each month and numerals from one to thirty-one. Small pieces of opaque material which will adhere to the sheet are sized to overly any day, month and numeral so that any calendar date can be indicated by adhering the pieces of opaque material to the rear of the transparent letters and numerals to define the month, day and the numerical date. The calendar is distinguishable for being limited to a calendar.

U.S. Pat. No. 4,173,082 issued on Nov. 6, 1979, to Joan Niquette describes paper sheets for teaching writing skills containing three module staffs of contiguous, distinctly shaded bands of equal width printed with non-photographically reproducible ink on a sheet. The bands of each module are spaced from a similar module by a non-colored band, and an uncolored area is provided about the periphery of the sheet. Letters are printed or written commencing in the space of the middle one of shaded bands of each module to teach writing in an area rather than on a line. The ascending and descending portions of the letters are formed on the upper and lower bands to teach proper proportioning of the letters and the words formed on any one staff are spaced from words on an adjacent staff and the periphery of the paper by the non-colored areas to stimulate proper spacing and margination. The paper is distinguishable for requiring shaded bands printed with non-photographically reproducible ink.

U.S. Pat. No. 4,250,642 issued on Feb. 17, 1981, to Harald Riehle describes a rectangular planar planning aid device comprising a transparent flexible foil sheet having adhesive on its top surface for adhesion of planning elements and/or symbols having smooth surfaces. The foil is applied to another sheet containing a pictorial representation. The device is distinguishable for requiring an adhesive coated foil sheet.

U.S. Pat. No. 4,652,239 issued on Mar. 24, 1987, to Barnett J. Brimberg describes a space planning system comprising a flexible cast-colored paper substrate with a smooth, flexible sheet of static cling vinyl electrostatically adhered to the coated surface. The vinyl sheet is die cut into a plurality of graphic symbol elements in the shapes of plan or axonometric views of wall sections, windows, furniture, appliances, plants, and the like to be arranged in a floor space to be planned. In use, the graphic symbol elements are peeled from the substrate and electrostatically adhered to the work surface of a flexible work sheet to design a space and arrangement of articles on the space. A first type of work sheet of clear transparent polyester is reverse printed with a square or axonometric grid. A second type of work sheet can be secured ton one or both sides of a rigid board. The devices are distinguishable for requiring a plastic sheet cut into a plurality of graphic symbol elements such as wall sections, windows, furniture, appliances, and plants to be mounted on a flexible work sheet.

U.S. Pat. No. 4,741,119 filed on May 3, 1988, to Stanley J. Baryla describes an electrostatic display board comprising a transparent display window over a paper sheet document clinging electrostatically on a dielectric plastic backing board having an easel-type support leg. The display board is distinguishable for requiring a transparent display window sheet over a paper sheet.

U.S. Pat. No. 5,370,538 issued on Dec. 6, 1994, to Fahim R. Sidray describes instructive devices for transforming pictorial images in orthogonal dimensions comprising the optional use of overhead projectors. A composition of translations or a combination of rotation and translations in two orthogonal dimensions are obtained to locate superimposed picture images to any selective location with respect to stationary pictures. Another embodiment provides animated motion of pictures, diagrams or graphs as a mathematics teaching aid. The devices are distinguishable for requiring projectors.

U.S. Pat. No. 5,954,512 issued on Sep. 21, 1999, to David M. Fruge describes a behavior tracking board providing recording and monitoring of one or more individuals' general behavior. The board comprises one or more horizontal rows, with each row corresponding to a child. Each row includes a movable marker captured in a track and moved from one side to the opposite left side. Alternatively, markers could initially be centrally located, and moved to the right for exemplary behavior and to the left for less than desirable behavior. The behavior tracking board is distinguishable for requiring tracks and markers.

U.S. Pat. No. 6,159,329 issued on Dec. 12, 2000, to Charles M. Tschanz describes self-adhesive graph appliqués used on small graphs, text pages or calculations using small adhesive-backed appliqués or labels which have been preprinted with a graphical coordinate grid. The appliqués are distinguishable for being required to be preprinted with a graphical coordinate grid.

U.K. Patent Specification No. 627,881 published on Aug. 17, 1949, for Ralph W. Furness et al. describes a sign comprising a sheet having a highly glazed surface, and letters, numerals or the like characters in the form of flexible pieces of thin sheet polyvinyl chloride having a highly glazed surface being mounted by pressing. The device is distinguishable for requiring the pressure-mounting of letter, numerals and the like on a sheet.

U.K. Patent Specification No. 842,480 published on Jul. 27, 1960, for Hermann Holtz describes a ferromagnetic chart for statistical purposes comprising an assortment of magnetic stick-on articles such as blocks, circles, musical notes, chain links, and the like posted on a flexible geographical chart. The device is distinguishable for requiring magnetic articles to be posted on a flexible ferromagnetic chart.

None of the above inventions and patents, taken either singly or in combination, is seen to describe the instant invention as claimed. Thus, graphic organizers solving the aforementioned problems is desired.

### SUMMARY OF THE INVENTION

The graphic organizer is a sheet of vinyl material having an electrostatic property whereby the sheet will cling on contact to a surface such as the surface of a white board. The graphic organizer is pre-printed with any of several indicia of a form commonly used, for example, in a classroom. In a first embodiment, the graphic organizer bears the indicia of a monthly calendar. A second embodiment is a weekly calendar. A third embodiment is a lined sheet having regularly spaced lines or, alternatively, a lined sheet having doubled lines alternating with dashed lines. A fourth embodiment is a coordinate graph layout with numbered positive and negative X and Y axes. A fifth embodiment is a coordinate graph layout having X and Y axes defining a single quadrant. The single quadrant coordinate graph may be oriented to illustrate any of the four quadrants of a Cartesian coordinate system. Separate overlay strips are numbered to label the axes.

The vinyl sheet material may be transparent or opaque, as various advantages of either will be apparent. In use, a graphic organizer is applied to a surface, and particularly to the surface of a white board. An erasable dry marker pen may be used to write or mark on the graphic organizer. Thus, for example, when during the course of teaching mathematics it is desirable to perform an exercise on the white board that requires an X-Y coordinate grid, a graphic organizer bearing the coordinate graph layout is applied to the white board surface. Graphs or equations, or other markings, which are relevant to the exercise, may be marked on the graphic organizer to illustrate the exercise, and the graphic organizer may be quickly removed and replaced to illustrate another exercise or to move on to another topic without destroying the markings applied to the graphic organizer.

In addition to the various indicia that may be printed on the surface of the graphic organizer, additional, smaller pieces of the vinyl material may be provided with particular indicia printed thereon. For example, small overlay pieces of the vinyl material imprinted with the days of a week, or numbers indicating the days of the month, may be provided with a graphic organizer having the indicia of a grid for a monthly or weekly calendar. The small overlay pieces may be rearranged on the graphic organizer to accommodate different calendar formats or different calendar months.

Additionally, small removable adhesive labels or magnetic overlay pieces may be used over the corners of the graphic organizer, to help stabilize the graphic organizer and prevent the corners from peeling away from the white board during use. When magnetic overlay pieces are used, the white board may contain small permanent magnets to which the magnetic overlay pieces may be attracted, or the entire board may be made from a permanent magnetic material. Optionally, the graphic organizer may be made from flexible, permanent magnetic sheets that will secure to the magnetic board.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a top perspective view of a first embodiment of a graphic organizer according to the present invention, the graphic organizer bearing indicia of a monthly calendar sheet.

FIG. 2 is a top perspective view of a second embodiment of a graphic organizer according to the present invention, the graphic organizer bearing indicia of a calendar grid, along with separate overlay pieces bearing indicia of days of the week and numeric indicia.

FIG. 3A is a top perspective view of a first species of a third embodiment of a graphic organizer according to the present invention, the graphic organizer bearing indicia of parallel ruled lines.

FIG. 3B is a top perspective view of a second species of a third embodiment of a graphic organizer according to the present invention, the graphic organizer bearing indicia of parallel double-ruled lines alternating with dashed lines.

FIG. 4 is a top perspective view of a fourth embodiment of a graphic organizer according to the present invention, the graphic organizer bearing indicia of a Cartesian graph design with numbered positive and negative X-Y axes.

FIG. 5 is a top perspective view of a fifth embodiment of a graphic organizer according to the present invention, the graphic organizer bearing indicia of a Cartesian graph design and X and Y axes, along with numeric overlays bearing numeric indicia for the X-Y axes.

FIG. 6 is a plan view of the numeric overlays as shown in FIG. 5.

Similar reference characters denote corresponding features consistently throughout the attached drawings.

### DETAILED DESCRIPTION OF THE PREFERRED EMBODIMENTS

The present invention is directed to five embodiments of a graphic organizer having the purpose of increasing the efficiency of teaching or planning meetings with a visual aid. Teachers and students no longer have to stare into a bright overhead display shown on a screen in a dark room. These educational tools facilitate the teaching of a lesson by saving the time required to draw the specific grids and to enable the insertion and erasures of indicia. Made from vinyl sheeting having an inherent electrostatic property that causes the sheeting to adhere to a surface such as a white board, a graphic organizer according to this invention may be removably placed on such surface, marked on with a dry erase type of marker, and removed without destroying the markings. Thus, a classroom exercise illustrated on one graphic organizer may be removed for another lesson, and replaced for later review.

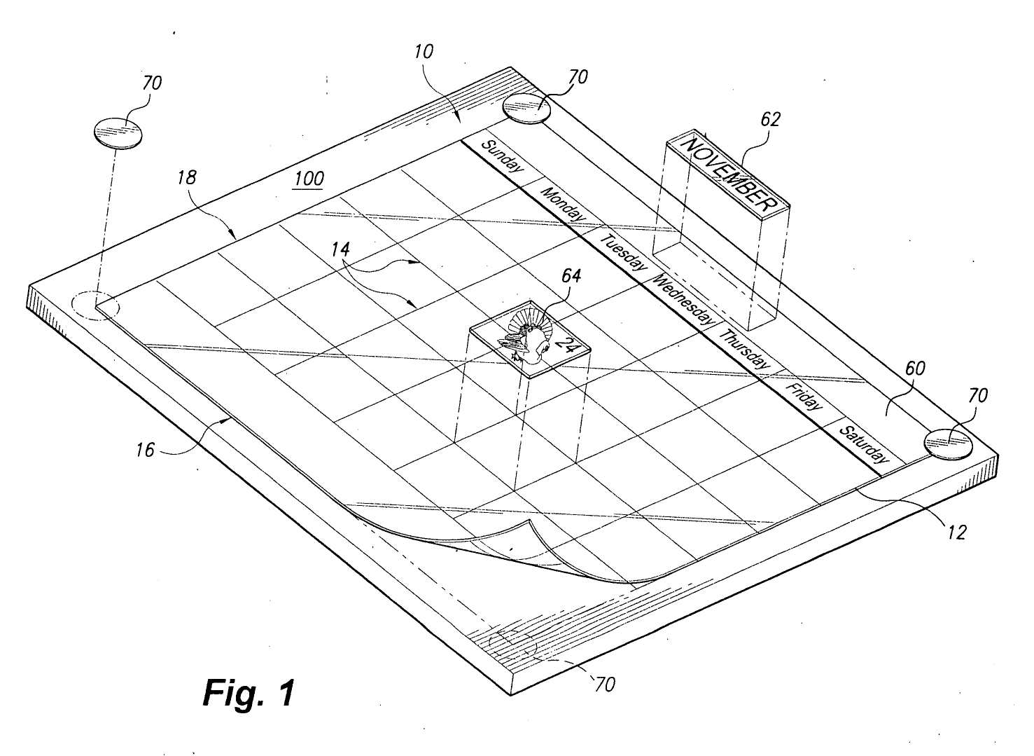

Turning now to FIG. 1, a first embodiment of a graphic organizer 10 is shown overlying a rectangular white board 100. The graphic organizer 10 comprises a flexible substrate 12 having visual indicia of a calendar, including gridlines 14 defining seven columns 16 titled with the days of the week and five rows 18 for the weeks in a month. A blank margin 60 along the top of the graphic organizer 10 provides space for a removable title overlay 62. The flexible substrate 12 is made of a sheet material having an inherent electrostatic property that causes the material to adhere to a surface such as a white board 100, such as a thin vinyl sheeting. The title overlay 62 is made from the same material as the flexible substrate 12, and so will cling to the flexible substrate 12 when placed on the flexible substrate 12. It can be recognized that additional overlays may be provided, allowing various functional and decorative indicia to be added to the graphic organizer 10, such as a decorative overlay 64, showing seasonal and other images such as a Christmas tree in December, a turkey for Thanksgiving, snowflakes during winter months, and various other images. The visual indicia is painted, silk-screened, or otherwise printed on the surface of the flexible substrate 12, or on overlay pieces, preferably in a dark color, such as black, cranberry, dark green, dark blue, or dark violet, to contrast with an underlying white board 100. The graphic organizer 10 may be marked with a dry erasable marker (not shown). The graphic organizer 10 is rectangular, and can range in horizontal and vertical dimensions from several inches to several feet. It can be recognized that a graphic organizer 10 of large dimensions is suited for use, for example, in a classroom situation, overlaid on a white board 100 or the like to be viewed by students in a classroom. Alternatively, a graphic organizer 10 of small dimensions may be stored in a notebook and individually by individual students in the classroom. The graphic organizer 10 can be used on a variety of surfaces, including a white board 100 surface, a glass surface such as a window, and others.

Additionally, small removable adhesive labels or magnetic overlay pieces 70 may be used over the corners of the graphic organizer 10, to help stabilize the graphic organizer and prevent the corners from peeling away from the white board 100 during use. When magnetic overlay pieces 70 are used, the white board 100 may contain small permanent magnets to which the magnetic overlay pieces 70 may be attracted, or the entire board may be made from a permanent magnetic material. Optionally, the graphic organizer 10 may be made from flexible, permanent magnetic sheets that will secure to the magnetic board. The small removable adhesive labels or magnetic overlay pieces 70 may be formed in any shape, such as geometric shapes and shapes of objects relating to the subjects of the graphic organizer 10, and may have functional and decorative indicia painted, silk-screened, or otherwise printed on the surface of the adhesive labels or magnetic overlay pieces 70. The adhesive labels or magnetic overlay pieces 70 may also be used with any of the graphic organizer embodiments enumerated hereforth.

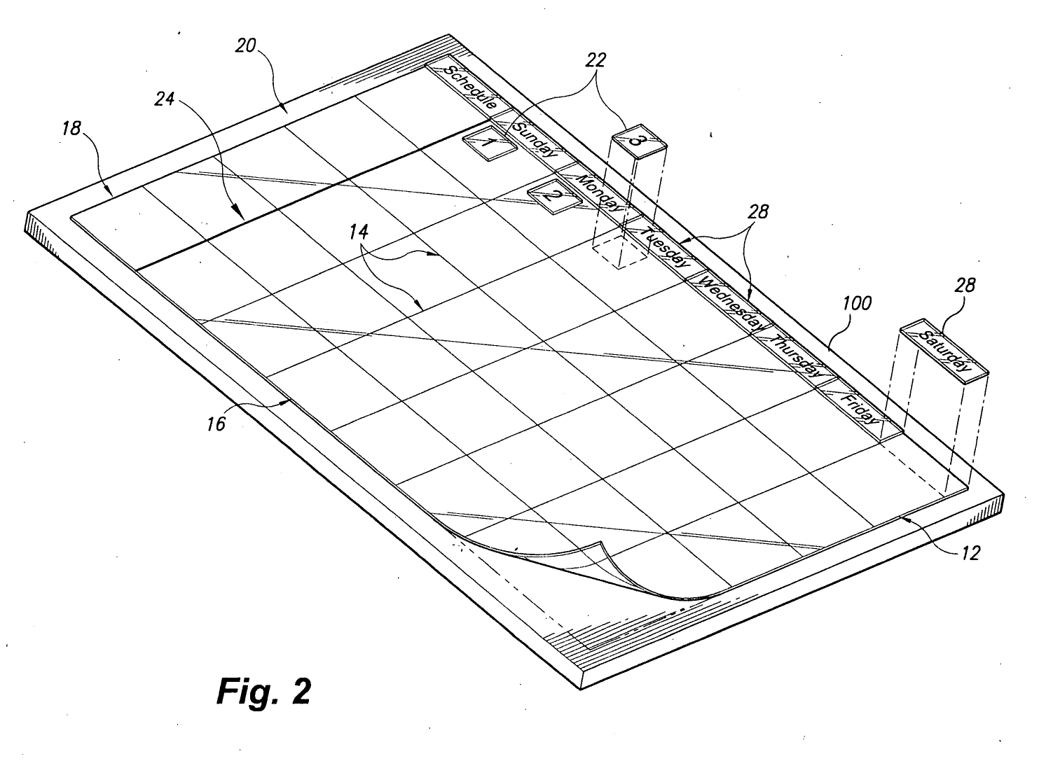

Turning now to FIG. 2, a second embodiment of a graphic organizer 20 is illustrated. The second embodiment of the graphic organizer 20 bears the visual indicia of a week or planning calendar, including gridlines 14 defining several rows 18 and a column 16 for each of the seven weekdays, and an additional column 26 for scheduling, the additional column 26 being demarked by line 24 having greater thickness than the gridlines 14. The visual indicia are printed on the flexible substrate 12. Above the columns 16, 26 is a row of heading overlays 28 indicating the scheduling column or indicating a day of the week. The heading overlays 28 are separate, small pieces made from the same material as the flexible substrate 12, having appropriate indicia printed thereon to identify the days of a week, and to identify a scheduling column. The heading overlays 28 are overlaid on the flexible substrate 12, removably adhering by virtue of their electrostatic property, allowing the week or planning calendar to be rearranged. Numeric overlays 22 are additional separate, small pieces made from the same material as the flexible substrate 12, and have numeric indicia printed thereon. The numeric overlays 22 may be overlaid on the flexible substrate 12, for example to identify dates. Additionally, the graphic organizer 20 may be used, with all of the overlays removed, as a blank grid for a variety of purposes.

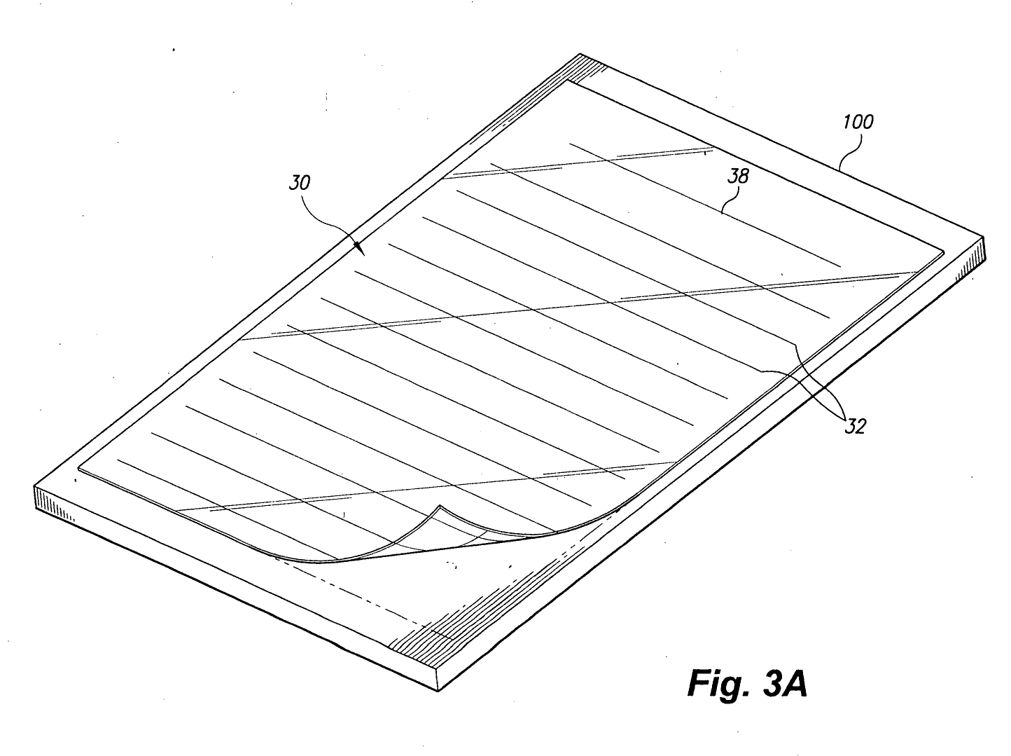

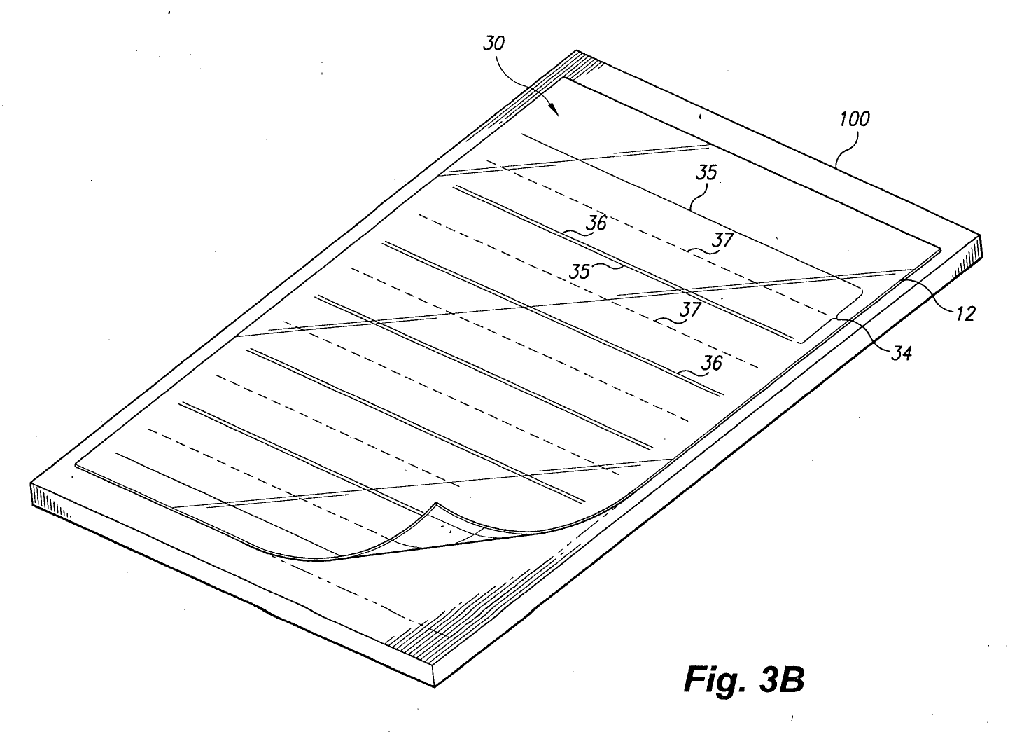

Turning now to FIGS. 3A and 3B, a third embodiment of a graphic organizer 30 is illustrated, bearing visual indicia of parallel ruled lines printed on the flexible substrate 12. In a first species of the third embodiment, seen in FIG. 3A, the visual indicia of parallel ruled lines consists of solid, evenly spaced, and parallel ruled lines 32, each of the parallel ruled lines 32 being horizontal and extending substantially across the width of the flexible substrate 12. A title line 36 is centered at the top of the graphic organizer 10, separated above the ruled lines 32.

In a second species of the third embodiment, seen in FIG. 3A, graphic organizer 30 bears visual indicia of parallel lines comprising six line groups 34, each line group 34 having an upper 35 and a lower 37 solid ruled line, and a single dashed line 36 between the upper 35 and lower 37 solid ruled lines. All of the lines 35, 36, 37 are horizontal and extend substantially across the width of the flexible substrate 12. This arrangement of parallel lines is useful for teachers to demonstrate, and for younger students to practice, writing skills such as writing upper and lower case printed and cursive letters in a straight line. In each of the line groups 34, the upper 35 solid ruled line is an upper margin for practicing capital printed or cursive letters; the dashed lines 36 are guidelines for the height of the lower case printed or cursive letter, and the lower 37 solid ruled line is a baseline for the letters. Both species of the graphic organizer 30 may be used as a white board 100 overlay, or, in a smaller size, may be used individually by students at the student's desk to practice the student's individual penmanship. The graphic organizers 30 help students learn to write paragraphs with titles in evenly spaced and parallel lines, and help the students with basic handwriting skills.

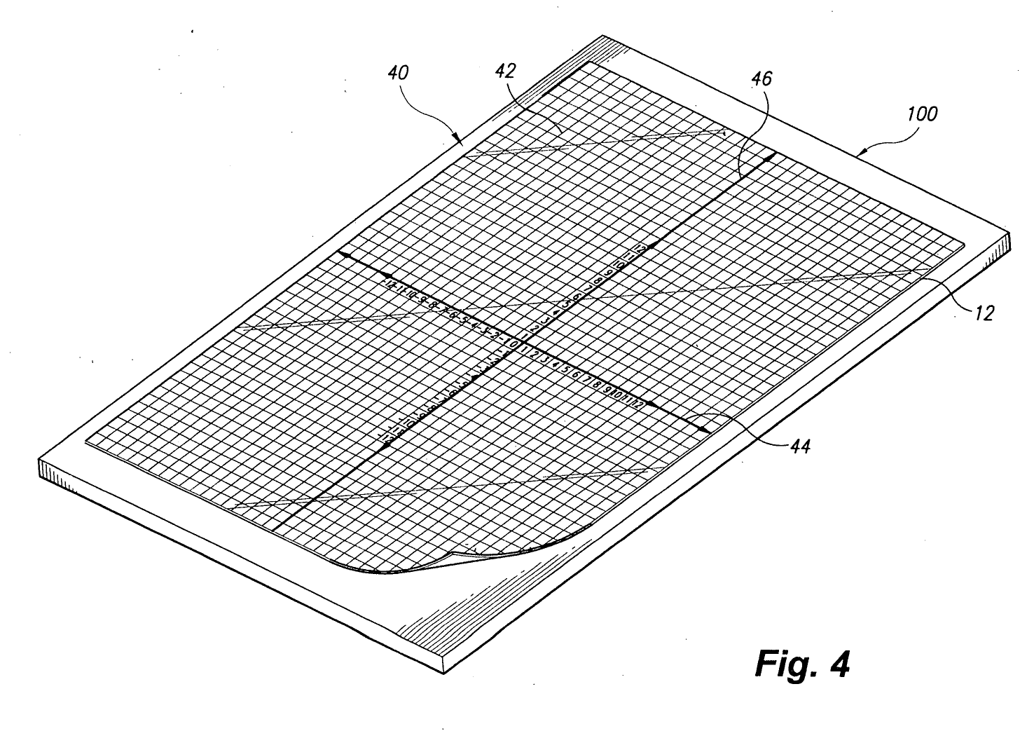

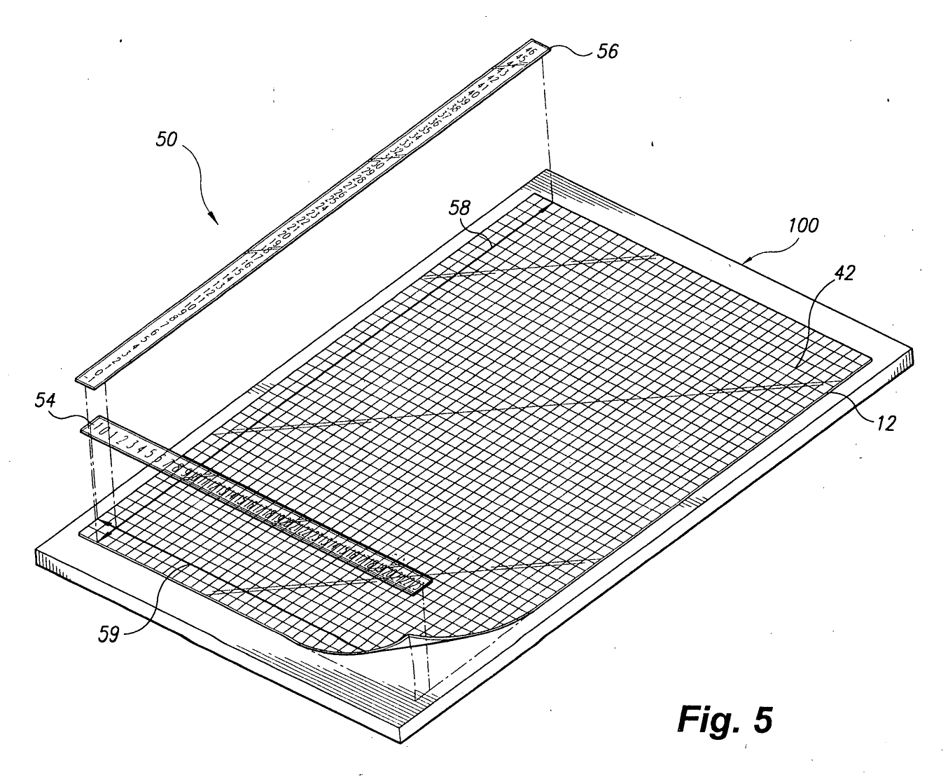

Turning now to FIG. 4, a fourth embodiment of a graphic organizer 40 is illustrated. The fourth embodiment of the graphic organizer 40 bears the visual indicia of a Cartesian grid graph 42, printed on the flexible substrate 12, along with a positive and negative numbered horizontal X axis 44 and a similar numbered vertical Y axis 46 defining four quadrants. Alternatively, the X axis 44 and the Y axis 46 may be located to define a single quadrant. It can be recognized that the numbering of the axes 44 and 46 may be omitted from the flexible substrate 12, and replaced with separate numeric overlay strips bearing appropriate numbering indicia for numbering the axes 44 and 46. Similar numeric overlay strips are discussed below, and illustrated with the embodiment of FIG. 5. This embodiment can be used in student classes from grade school through college to teach coordinate number pairs, linear equations, slope, quadratic equations, and other lessons.

Turning now to FIG. 5, a fifth embodiment of a graphic organizer 50 is illustrated. The fifth embodiment of the graphic organizer 50 bears the visual indicia of a Cartesian grid graph 42 printed on the flexible substrate 12, similar to the graphic organizer 40 discussed above. Additional indicia include a bold X axis 59, printed near the bottom edge of the Cartesian grid graph 42, and a bold X axis 58, printed near the left hand edge of the Cartesian grid graph 42. Separate numeric overlay pieces are provided for numbering of each of the X axis 54 and the Y axis 56.

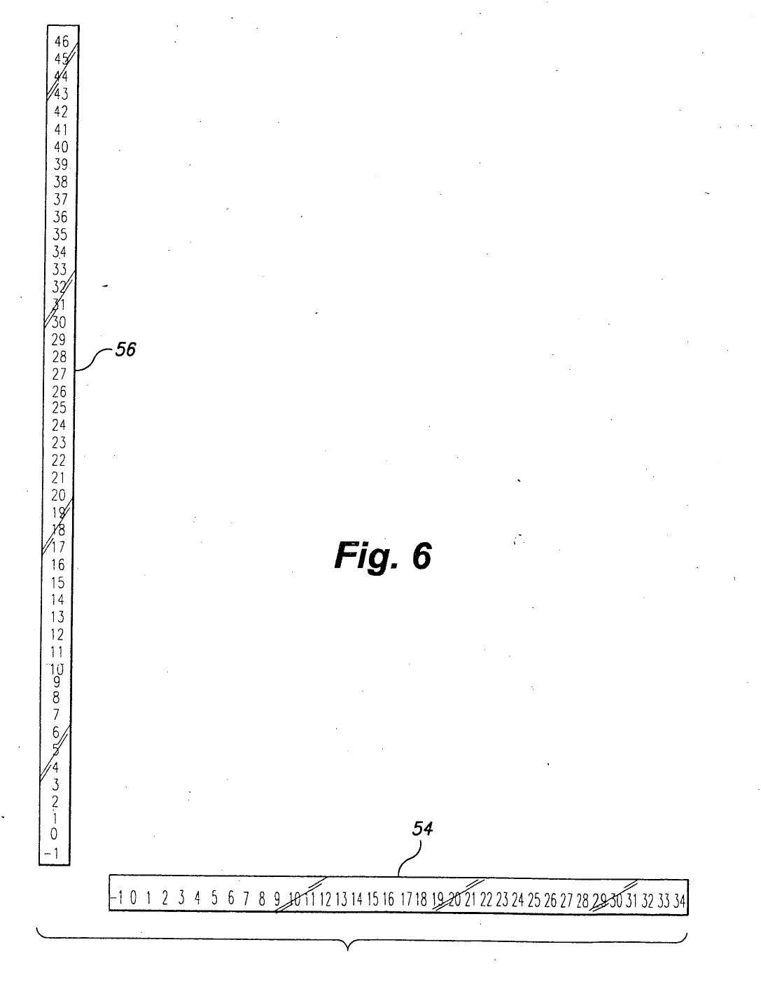

Referring also to FIG. 6, an X axis numeric overlay 59 has numeric indicia printed thereon oriented to be read with the X axis numeric overlay 59 oriented in a horizontal position along the X axis 54, while a Y axis numeric overlay 58 has numeric indicia printed thereon oriented to be read with the Y axis numeric overlay 58 oriented in a horizontal position along the Y axis 56. With the numeric overlays 58, 59 positioned on the graphic organizer 50 over the X and Y axes 54, 55, the numeric indicia of the numeric overlays 58, 59 are in alignment with the Cartesian grid graph 42, the numeric indicia correctly numbering the axes. It can be recognized that the graphic organizer 50 may be placed onto a white board in any orientation, depicting any of the four Cartesian quadrants. Thus, it can further be recognized that the X axis numeric overlay 59 and the Y axis numeric overlay 58 may be imprinted with numeric indicia according to any quadrant, or any numbering system. The X axis numeric overlay 59 and the Y axis numeric overlay 58 are made from the same material as the flexible substrate 12 and will cling to the flexible substrate 12 when placed on the flexible substrate 12.

Thus, a variety of educational tools for use on a white board or the like comprising a transparent or opaque plastic overlay sheet with printed indicia has been shown to aid students in penmanship, grammar and understanding mathematics.

It is to be understood that the present invention is not limited to the embodiments described above, but encompasses any and all embodiments within the scope of the following claims.

1-3. (canceled)

4. A graphic organizer, comprising:
a flexible substrate made from a material having a property such that the flexible substrate tends to cling to a surface;
visual indicia of a Cartesian coordinate grid printed on said flexible substrate;
visual indicia of X and Y axes printed on said flexible substrate;
a first elongated overlay strip removably overlaid on said flexible substrate, the first elongated overlay strip having numeric indicia numbering said X axis printed thereon; and
a second elongated overlay strip removably overlaid on said flexible substrate, the second elongated overlay strip having numeric indicia numbering said Y axis printed thereon.
